(19) United States
(12) Patent Application Publication
(10) Pub. No.: US 2026/0158857 A1
(43) Pub. Date: Jun. 11, 2026

(54) AIR CONDITIONING SYSTEM AND METHOD FOR CONTROLLING SAME

(71) Applicant: NGK INSULATORS, LTD., Nagoya-City (JP)

(72) Inventor: Takafumi HAMADA, Nagoya-Shi (JP)

(73) Assignee: NGK INSULATORS, LTD., Nagoya-City (JP)

(21) Appl. No.: 19/396,539

(22) Filed: Nov. 21, 2025

(30) Foreign Application Priority Data
Dec. 9, 2024 (JP) 2024-214637
Oct. 6, 2025 (JP) 2025-168638

(51) Int. Cl. B60H 1/00

(52) U.S. Cl. CPC B60H 1/00821; B60H 1/00564

(57) ABSTRACT

An air conditioning system includes: a flow path through which air can flow; an air conditioning device provided in the flow path and configured to execute an adsorption mode in which at least one adsorption target substance is adsorbed and a regeneration mode in which the adsorption target substance is desorbed, the air conditioning device including a substrate portion heatable by application of voltage, and an adsorption portion containing an adsorbent configured to adsorb and desorb the adsorption target substance; and a control unit configured to control a flow rate of the air flowing through the flow path and the air conditioning device. The control unit controls a ratio of a flow rate [L/min] of the air to an average power [W] supplied to the air conditioning device to 0.10 to 1.90 during the regeneration mode of the air conditioning device.

### CROSS REFERENCE TO RELATED APPLICATIONS

This application claims the benefit of priority to Japanese Patent Applications No 2024-214637 filed on Dec. 9, 2024 and No 2025-168638 filed on Oct. 6, 2025 with the Japanese Patent Office, the entire contents of which are incorporated herein by reference in its entirety.

### FIELD OF THE INVENTION

This invention relates to an air conditioning system and a method for controlling the same.

### BACKGROUND OF THE INVENTION

In various buildings such as offices, schools, and houses, and various types of vehicles such as automobiles, there are increasing requirements for improvement of vehicle interior environment. Specific requirements illustrate reduction of an amount of CO₂ in a room interior to suppress drowsiness, control of humidity in the room interior, and removal of harmful volatile components such as odor components and allergy-causing components in the room interior. The effective measure for such requirements includes ventilation, but the ventilation causes a large loss of heater energy in winter, leading to a decreased energy efficiency in winter. In particular, a battery electric vehicle (BEV) has a problem that its cruising range is significantly reduced due to its energy loss.

As a method for solving the above problems, a vehicle purifying system (air conditioning system) is proposed, which includes: a heater element (air conditioning device) including a honeycomb structure having an outer peripheral wall and partition walls provided on an inner side of the outer peripheral wall, the partition walls defining a plurality of cells each extending from one end face to other end face of the honeycomb structure to form a flow path, at least the partition wall being made of a material having a PTC property; a pair of electrodes including a first electrode provided on the one end face and a second electrode provided on the other end face; and a functional material (adsorbent)-containing layer provided on a surface of each partition wall; as well as an inflow pipe communicating a vehicle interior with an inlet end face of the heater element; and an outflow pipe having a first path (first flow path) that communicates an outlet end face of the heater element with the vehicle interior, wherein the outflow pipe has a first path that communicates an outlet end face of the heater element with the vehicle interior and a second path (second flow path) that communicates the outlet end face of the heater element with a vehicle exterior, and wherein the system includes a switching valve configured to switch an air flow circulating through the outflow pipe between the first path and the second path (for example, Patent Literature 1). This vehicle air purification system is capable of adsorbing CO₂ and other substances through the functional material-containing layer of the heater element, and the functional material-containing layer can be regenerated by heating the heater element.

In the regeneration process of an air conditioning device, although increasing the heating amount of the air conditioning device (supplying greater power to the air conditioning device) increases the amount of the desorption target substance, a lower flow rate of air flowing through the air conditioning device tends to accumulate the adsorption target substance, which prevents effective progression of the regeneration mode. On the other hand, an excessive high flow rate of air flowing through the air conditioning device leads to a decrease in the temperature of the air conditioning device, resulting in a lower amount of the adsorption target substance released.

This invention has been made to solve the problems described above, and an object of this invention is to provide an air conditioning system and a method for controlling the same, which can efficiently perform the regeneration mode of the air conditioning device.

### CITATION LIST

### Patent Literature

[Patent Literature 1] WO 2023/074202 A1

### SUMMARY OF THE INVENTION

As a result of intensive studies for air conditioning systems including air conditioning devices, the inventor has found that the above problems can be solved by controlling, during the regeneration mode of the air conditioning device, a ratio of a flow rate of air [L/min] to an average power [W] supplied to the air conditioning device, or a ratio of the maximum desorption amount [g/s] of the adsorption target substance in the air conditioning device to the flow rate of the air [m³/s], to a predetermined range. In other words, this invention is exemplified as follows:

<1> An air conditioning system, including:
a flow path through which air can flow;
at least one air conditioning device provided in the flow path and configured to execute an adsorption mode in which at least one adsorption target substance is adsorbed and a regeneration mode in which the adsorption target substance is desorbed, the air conditioning device including a substrate portion heatable by application of voltage, and an adsorption portion containing an adsorbent configured to adsorb and desorb the adsorption target substance; and
a control unit configured to control a flow rate of the air flowing through the flow path and the air conditioning device,
wherein the control unit may control a ratio of a flow rate [L/min] of the air to an average power [W] supplied to the air conditioning device to 0.10 to 1.90 during the regeneration mode of the air conditioning device.

<2> The air conditioning system according to [1], wherein the control unit may control the ratio of the flow rate [L/min] of the air to the average power [W] supplied to the air conditioning device to 0.20 to 1.70 during the regeneration mode of the air conditioning device.

<3> The air conditioning system according to [1] or [2], wherein the control unit may change at least one of the power supplied to the air conditioning device and the flow rate of the air during the regeneration mode of the air conditioning device.

<4> An air conditioning system, including:
a flow path through which air can flow;
at least one air conditioning device provided in the flow path and configured to execute an adsorption mode in which at least one adsorption target substance is adsorbed and a regeneration mode in which the adsorption target substance is desorbed, the air conditioning device including a substrate portion heatable by application of voltage, and an adsorption portion containing an adsorbent configured to adsorb and desorb the adsorption target substance; and
a control unit configured to control a flow rate of the air flowing through the flow path and the air conditioning device,
wherein the control unit may control the flow rate of the air during the regeneration mode of the air conditioning device to satisfy the following conditions:
(1) when a temperature of the air is 120° C. or higher, a ratio of a maximum desorption amount [g/s] of the adsorption target substance in the air conditioning device to the flow rate [m³/s] of the air is 1950 or less;
(2) when the temperature of the air is 90° C. or higher and lower than 120° C., the ratio of the maximum desorption amount [g/s] of the adsorption target substance in the air conditioning device to the flow rate [m³/s] of the air is 600 or less;
(3) when the temperature of the air is 70° C. or higher and lower than 90° C., the ratio of the maximum desorption amount [g/s] of the adsorption target substance in the air conditioning device to the flow rate [m³/s] of the air is 300 or less;
(4) when the temperature of the air is 50° C. or higher and lower than 70° C., the ratio of the maximum desorption amount [g/s] of the adsorption target substance in the air conditioning device to the flow rate [m³/s] of the air is 130 or less; and
(5) when the temperature of the air is lower than 50° C., the ratio of the maximum desorption amount [g/s] of the adsorption target substance in the air conditioning device to the flow rate [m³/s] of the air is 60 or less.

<5> The air conditioning system according to any one of <1> to <4>, wherein the air conditioning device may include:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air;
an adsorbing layer containing the adsorbent, the adsorbing layer being provided on a surface of each of the partition walls; and
a pair of electrodes provided on the first end face and the second end face of the honeycomb structure, or on the outer peripheral wall parallel to an extending direction of the cells of the honeycomb structure.

<6> The air conditioning system according to <5>, wherein at least the partition walls of the honeycomb structure may be made of a material having a PTC property.

<7> The air conditioning system according to any one of <1> to <6>, wherein the flow path may branch into a first flow path for allowing the air to flow into a room interior and a second flow path for discharging the air to a room exterior on a downstream side of the air conditioning device, and may further include a first valve configured to switch the flow of the air between the first flow path and the second flow path.

<8> The air conditioning system according to <7>, wherein the control unit may be configured to control the first valve, and the control unit may switch the first valve so that the air flows into the first flow path during the adsorption mode, switch the first valve so that the air flows into the second flow path during the regeneration mode, and heat the substrate portion.

<9> The air conditioning system according to any one of <1> to <8>, which may further include a ventilation fan for adjusting the flow rate of the air within the flow path,
wherein the control unit may control the flow rate of the air by adjusting a rotation speed of the ventilation fan.

<10> The air conditioning system according to any one of <1> to <9>, wherein the adsorption target substance may be moisture.

<11> A method for controlling an air conditioning system, the air conditioning system including:
a flow path through which air can flow;
an air conditioning device provided in the flow path and configured to execute an adsorption mode in which at least one adsorption target substance is adsorbed and a regeneration mode in which the adsorption target substance is desorbed, the air conditioning device including a substrate portion heatable by application of voltage, and an adsorption portion containing an adsorbent configured to adsorb and desorb the adsorption target substance; and
a control unit configured to control a flow rate of the air flowing through the flow path and the air conditioning device,
wherein the control unit may control a ratio of a flow rate [L/min] of the air to an average power [W] supplied to the air conditioning device to 0.10 to 1.90 during the regeneration mode of the air conditioning device.

<12> The method for controlling an air conditioning system according to <11>, wherein the control unit may control the ratio of the flow rate [L/min] of the air to the average power [W] supplied to the air conditioning device to 0.20 to 1.70 during the regeneration mode of the air conditioning device.

<13> The method for controlling an air conditioning system according to <11> or <12>, wherein the control unit may change at least one of the power supplied to the air conditioning device and the flow rate of the air during the regeneration mode of the air conditioning device.

<14> A method for controlling an air conditioning system, the air conditioning system including:
a flow path through which air can flow;
an air conditioning device provided in the flow path and configured to execute an adsorption mode in which at least one adsorption target substance is adsorbed and a regeneration mode in which the adsorption target substance is desorbed, the air conditioning device including a substrate portion heatable by application of voltage, and an adsorption portion containing an adsorbent configured to adsorb and desorb the adsorption target substance; and
a control unit configured to control a flow rate of the air flowing through the flow path and the air conditioning device,
wherein the control unit may control the flow rate of the air during the regeneration mode of the air conditioning device to satisfy the following conditions:
(1) when a temperature of the air is 120° C. or higher, a ratio of a maximum desorption amount [g/s] of the adsorption target substance in the air conditioning device to the flow rate [m³/s] of the air is 1950 or less;
(2) when the temperature of the air is 90° C. or higher and lower than 120° C., the ratio of the maximum desorption amount [g/s] of the adsorption target substance in the air conditioning device to the flow rate [m³/s] of the air is 600 or less;
(3) when the temperature of the air is 70° C. or higher and lower than 90° C., the ratio of the maximum desorption amount [g/s] of the adsorption target substance in the air conditioning device to the flow rate [m³/s] of the air is 300 or less;
(4) when the temperature of the air is 50° C. or higher and lower than 70° C., the ratio of the maximum desorption amount [g/s] of the adsorption target substance in the air conditioning device to the flow rate [m³/s] of the air is 130 or less; and
(5) when the temperature of the air is lower than 50° C., the ratio of the maximum desorption amount [g/s] of the adsorption target substance in the air conditioning device to the flow rate [m³/s] of the air is 60 or less.

### BRIEF DESCRIPTION OF THE DRAWINGS

FIG. 1 is an overall schematic configuration view of an air conditioning system according to Embodiment 1;

FIG. 2 is a schematic configuration view of another air conditioning system according to Embodiment 1;

FIG. 3 is a schematic configuration view of another air conditioning system according to Embodiment 1;

FIG. 4 is a schematic configuration view of another air conditioning system according to Embodiment 1;

FIG. 5 is a schematic configuration view of another air conditioning system according to Embodiment 1;

FIG. 6 is a schematic configuration view of another air conditioning system according to Embodiment 1;

FIG. 7A is a schematic view of a cross section of a typical air conditioning device used in an air conditioning system according to Embodiment 1 of this invention, which is parallel to a flow path direction;

FIG. 7B is a schematic cross-sectional view of the air conditioning device in FIG. 7A taken along the line a-a′; and

FIG. 8 is a schematic view of a heat pump cycle.

### DETAILED DESCRIPTION OF THE INVENTION

An air conditioning system according to this invention includes: a flow path through which air can flow; at least one air conditioning device provided in the flow path and configured to execute an adsorption mode in which at least one adsorption target substance is adsorbed and a regeneration mode in which the adsorption target substance is desorbed, the air conditioning device including a substrate portion heatable by application of voltage, and an adsorption portion containing an adsorbent configured to adsorb and desorb the adsorption target substance; and a control unit configured to control a flow rate of the air flowing through the flow path and the air conditioning device; wherein the control unit controls a ratio of a flow rate [L/min] of the air to an average power [W] supplied to the air conditioning device to 0.10 to 1.90 during the regeneration mode of the air conditioning device.

Also, the air conditioning system according to this invention includes: a flow path through which air can flow; at least one air conditioning device provided in the flow path and configured to execute an adsorption mode in which at least one adsorption target substance is adsorbed and a regeneration mode in which the adsorption target substance is desorbed, the air conditioning device including a substrate portion heatable by application of voltage, and an adsorption portion containing an adsorbent configured to adsorb and desorb the adsorption target substance; and a control unit configured to control a flow rate of the air flowing through the flow path and the air conditioning device, wherein the control unit controls the flow rate of the air during the regeneration mode of the air conditioning device to satisfy the following conditions:
(1) when a temperature of the air is 120° C. or higher, a ratio of a maximum desorption amount [g/s] of the adsorption target substance in the air conditioning device to the flow rate [m³/s] of the air is 1950 or less;
(2) when the temperature of the air is 90° C. or higher and lower than 120° C., the ratio of the maximum desorption amount [g/s] of the adsorption target substance in the air conditioning device to the flow rate [m³/s] of the air is 600 or less;
(3) when the temperature of the air is 70° C. or higher and lower than 90° C., the ratio of the maximum desorption amount [g/s] of the adsorption target substance in the air conditioning device to the flow rate [m³/s] of the air is 300 or less;
(4) when the temperature of the air is 50° C. or higher and lower than 70° C., the ratio of the maximum desorption amount [g/s] of the adsorption target substance in the air conditioning device to the flow rate [m³/s] of the air is 130 or less; and
(5) when the temperature of the air is lower than 50° C., the ratio of the maximum desorption amount [g/s] of the adsorption target substance in the air conditioning device to the flow rate [m³/s] of the air is 60 or less.

Further, in a method for controlling an air conditioning system according to this invention, the air conditioning system includes: a flow path through which air can flow; at least one air conditioning device provided in the flow path and configured to execute an adsorption mode in which at least one adsorption target substance is adsorbed and a regeneration mode in which the adsorption target substance is desorbed, the air conditioning device including a substrate portion heatable by application of voltage, and an adsorption portion containing an adsorbent configured to adsorb and desorb the adsorption target substance; and a control unit configured to control a flow rate of the air flowing through the flow path and the air conditioning device, and the control unit controls a ratio of a flow rate [L/min] of the air to an average power [W] supplied to the air conditioning device to 0.10 to 1.90 during the regeneration mode of the air conditioning device.

Furthermore, in a method for controlling an air conditioning system according to this invention, the air conditioning system includes: a flow path through which air can flow; at least one air conditioning device provided in the flow path and configured to execute an adsorption mode in which at least one adsorption target substance is adsorbed and a regeneration mode in which the adsorption target substance is desorbed, the air conditioning device including a substrate portion heatable by application of voltage, and an adsorption portion containing an adsorbent configured to adsorb and desorb the adsorption target substance; and a control unit configured to control a flow rate of the air flowing through the flow path and the air conditioning device, and the control unit controls the flow rate of the air during the regeneration mode of the air conditioning device to satisfy the following conditions:
(1) when a temperature of the air is 120° C. or higher, a ratio of a maximum desorption amount [g/s] of the adsorption target substance in the air conditioning device to the flow rate [m³/s] of the air is 1950 or less;
(2) when the temperature of the air is 90° C. or higher and lower than 120° C., the ratio of the maximum desorption amount [g/s] of the adsorption target substance in the air conditioning device to the flow rate [m³/s] of the air is 600 or less;
(3) when the temperature of the air is 70° C. or higher and lower than 90° C., the ratio of the maximum desorption amount [g/s] of the adsorption target substance in the air conditioning device to the flow rate [m³/s] of the air is 300 or less;
(4) when the temperature of the air is 50° C. or higher and lower than 70° C., the ratio of the maximum desorption amount [g/s] of the adsorption target substance in the air conditioning device to the flow rate [m³/s] of the air is 130 or less; and
(5) when the temperature of the air is lower than 50° C., the ratio of the maximum desorption amount [g/s] of the adsorption target substance in the air conditioning device to the flow rate [m³/s] of the air is 60 or less.

With such configurations described above, the air conditioning system and the method for controlling the same according to this invention can control the flow rate of the air to be suitable for the regeneration mode, thereby making it possible to efficiently perform the regeneration mode of the air conditioning device. Therefore, the air conditioning system and the method for controlling the same according to this invention can reduce the power consumption required for the regeneration mode of the air conditioning device, and in particular, can increase the driving range when they are used in electric vehicles.

Hereinafter, embodiments of the invention will be specifically described with reference to the drawings. It should be understood that the invention is not limited to the following embodiments, and those which have appropriately added changes, improvements and the like to the following embodiments based on knowledge of a person skilled in the art without departing from the spirit of the invention fall within the scope of the invention.

### Embodiment 1

The air conditioning system according to Embodiment 1 of the invention can be used in various buildings such as offices, schools, and homes, and in various vehicles such as automobiles. Among these, the air conditioning system according to Embodiment 1 can be suitably utilized for various vehicles such as automobiles. The vehicle includes, but not limited to, automobiles and electric rail cars. Non-limiting examples of the automobile include a gasoline vehicle, a diesel vehicle, a gas fuel vehicle using CNG (compressed natural gas) or LNG (liquefied natural gas), a fuel cell vehicle, an electric vehicle, and a plug-in hybrid vehicle. The air conditioning system according to Embodiment 1 of this invention can be particularly suitably used for a vehicle having no internal combustion engine such as electric vehicles and electric rail cars.

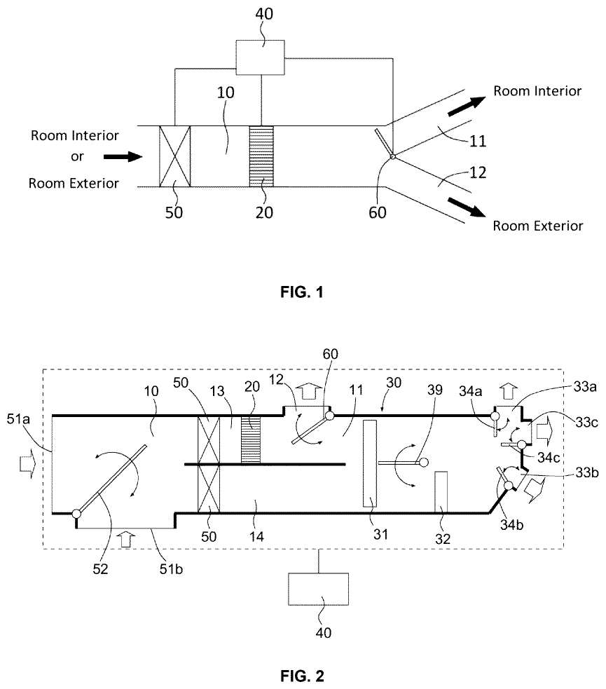

FIG. 1 is an overall schematic configuration view of an air conditioning system according to Embodiment 1.

As illustrated in FIG. 1, an air conditioning system according to Embodiment 1 of the invention includes: a flow path 10; at least one air conditioning device 20; and a control unit 40.

The flow path 10 can allow air in a room interior or from a room exterior to flow therethrough. Also, on a downstream side of the air conditioning device 20, the flow path 10 branches into a first flow path 11 for allowing the air to flow into the room interior (vehicle interior if it is for vehicles) and a second flow path 12 for allowing the air to flow out to the room exterior (vehicle exterior if it is for vehicles), and the branching portion is provided with a first valve 60 that can switch the flow of the air between the first flow path 11 and the second flow path 12.

The air conditioning device 20 is disposed in the flow path 10, and is capable of executing an adsorption mode in which at least one adsorption target substance is adsorbed and a regeneration mode in which the adsorption target substance is desorbed. The adsorption mode and the regeneration mode can repeatedly be executed. By executing the adsorption mode and the regeneration mode, the adsorption target substance in the air can be efficiently removed and discharged.

As used herein, the adsorption mode of the air conditioning device 20 means adsorption of the adsorption target substance in the air by allowing the air to flow through the air conditioning device 20. Further, the regeneration mode of the air conditioning device 20 means desorption of the adsorbed adsorption target substance by allowing the air to flow through the air conditioning device 20 while heating it. In the adsorption mode, the air that has adsorbed the adsorption target substance flows into the room interior through the first flow path 11. Further, in the regeneration mode, the air that has desorbed the adsorption target substance is discharged through the second flow path 12 to the room exterior.

The control unit 40 can control the flow rate of the air flowing through the flow path 10 and the air conditioning device 20.

A ventilation fan 50 for adjusting the flow rate of the air is provided in the flow path 10, and the control unit 40 can adjust the flow rate of the air by controlling the rotation speed of the ventilation fan 50. The control unit 40 and the ventilation fan 50 are electrically connected to each other.

The control unit 40 can also determine whether or not the air conditioning device 20 is heated by controlling a power source (not shown) electrically connected to the air conditioning device 20. The control unit 40 is also connected to the first valve 60 and can control the first valve 60. The control unit 40 switches the first valve 60 so that the air flows into the first flow path 11 during the adsorption mode, switches the first valve 60 so that the air flows into the second flow path 12 during the regeneration mode, and heats the substrate portion of the air conditioning device. With such a configuration, the adsorption mode and the regeneration mode of the air conditioning device 20 can be easily achieved.

In the air conditioning system having the structure described above, the control unit 40 controls a ratio of a flow rate [L/min] of the air to an average power [W] supplied to the air conditioning device 20 to 0.10 to 1.90 during the regeneration mode of the air conditioning device 20. This allows the heating amount of the air conditioning device 20 and the flow rate of the air to be suitable for the regeneration mode, thereby making it possible to efficiently perform the regeneration mode of the air conditioning device 20. From the viewpoint of stably ensuring this effect, it is preferable that the ratio of the flow rate [L/min] of the air to the average power [W] supplied to the air conditioning device 20 is 0.20 to 1.70.

The average power supplied to the air conditioning device 20 during the regeneration mode of the air conditioning device 20 is not particularly limited as long as the above ratio is satisfied, but it is typically 100 to 550 W. The flow rate of the air during the regeneration mode of the air conditioning device 20 is not particularly limited as long as the above ratio is satisfied, but it is typically 30 to 390 L/min.

The control unit 40 can change at least one of the power supplied to the air conditioning device 20 and the flow rate of the air during the regeneration mode of the air conditioning device 20. Specifically, during the regeneration mode of the air conditioning device 20, the control unit 40 may change the power supplied to the air conditioning device 20, may change the flow rate of the air fed to the air conditioning device 20, or may change both the power supplied to the air conditioning device 20 and the flow rate of the air. By changing at least one of the power supplied to the air conditioning device 20 and the flow rate of the air in this manner, the ratio of the flow rate of the air to the average power supplied to the air conditioning device 20 can be easily controlled within a predetermined range, thereby making it possible to efficiently perform the regeneration mode of the air conditioning device 20.

The air conditioning system according Embodiment 1 of this invention may further include an HVAC unit configured to execute heating and cooling by heating and cooling the air in the room interior and/or from the room exterior. The inclusion of the HVAC unit facilitates heating and cooling of the room interior.

Here, schematic configuration views of an air conditioning system including an HVAC unit are illustrated in FIGS. 2 to 6.

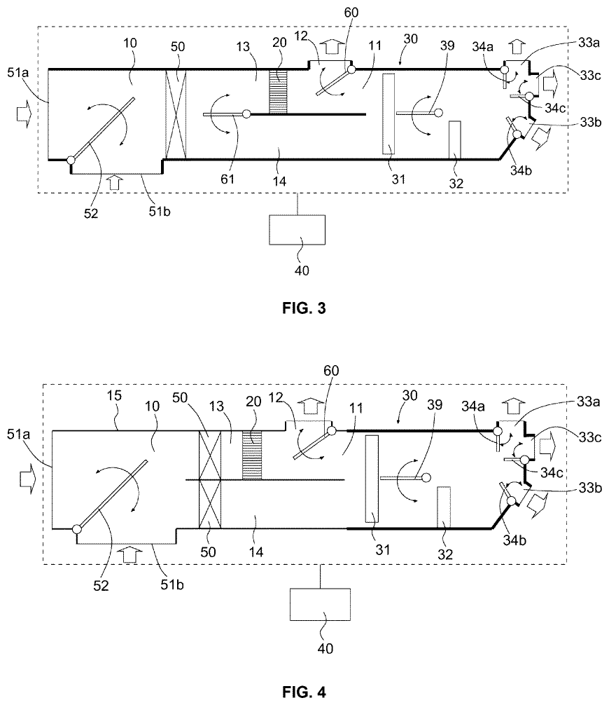

The air conditioning system illustrated in FIGS. 2 and 3 shows an embodiment in which the air conditioning device 20 is provided in the HVAC unit 30. Also, the air conditioning system illustrated in FIGS. 4 to 6 shows an embodiment in which the air conditioning device 20 is provided outside the HVAC unit 30, i.e., the air conditioning device 20 is provided on an upstream side of the HVAC unit 30.

The terms “upstream side” and “downstream side” as used herein are based on a flow direction of the air.

The HVAC unit 30 can execute a heating operation mode or a cooling operation mode.

As used herein, the heating operation mode of the HVAC unit 30 means that the air (inside air and/or outside air) is heated by a condenser 32 of the HVAC unit 30. Therefore, the HVAC unit 30 includes the condenser 32, and the condenser 32 is preferably connected to a heat pump cycle. Also, as used herein, a cooling by the HVAC unit 30 means that the air is cooled by an evaporator 31 of the HVAC unit 30. Therefore, the HVAC unit 30 includes the evaporator 31, and the evaporator 31 is preferably connected to the heat pump cycle.

Each of the above components and other components will be described below in detail.

### (1. Flow Path 10)

The flow path 10 is a region where the air can flow and is comprised of a duct (pipe) or a housing of the HVAC unit 30 (if it is provided with the HVAC unit 30). For example, in the air conditioning system illustrated in FIGS. 2 and 3, the flow path 10 is comprised of the housing of the HVAC unit 30. The air conditioning system illustrated in FIGS. 4 to 6 is composed of the housing of the HVAC unit 30 and the duct 15.

The shape and size of the flow path 10 are not particularly limited and may be appropriately adjusted depending on the type of the HVAC unit 30 and the duct 15 connected thereto.

It is preferable that, on a downstream side of the air conditioning device 20, the flow path 10 branches into a first flow path 11 for allowing the air to flow into the room interior and a second flow path 12 for allowing the air to flow out to the room exterior, and further includes a first valve 60 that can switch the flow of the air between the first flow path 11 and the second flow path 12. With such a configuration, the adsorption mode and the regeneration mode of the air conditioning device 20 can be easily achieved.

The flow path 10 preferably branches on an upstream side of the evaporator 31 into a third flow path 13 that is provided with the air conditioning device 20 and a fourth flow path 14 that is not provided with the air conditioning device 20. Such a configuration allows the air to always flow through the HVAC unit 30 to perform heating and cooling even if the air conditioning device 20 is regenerated.

In the air conditioning systems illustrated in FIGS. 2, 4 and 6, it is preferable to further include a ventilation fan 50 in the third flow path 13 on an upstream side of the air conditioning device 20. With this configuration, the air can be selectively allowed to flow through the third flow path 13.

The air conditioning system illustrated in FIGS. 2 and 4 preferably further includes the ventilation fan 50 in the fourth flow path 14. With this configuration, the air can be selectively allowed to flow through the fourth flow path 14. It should be note that, in the air conditioning system illustrated in FIG. 6, the air can be selectively allowed to flow through the forth flow path 14 or both the third flow path 13 and the fourth flow path 14 by activating the ventilation fan 50 of the HVAC unit 30.

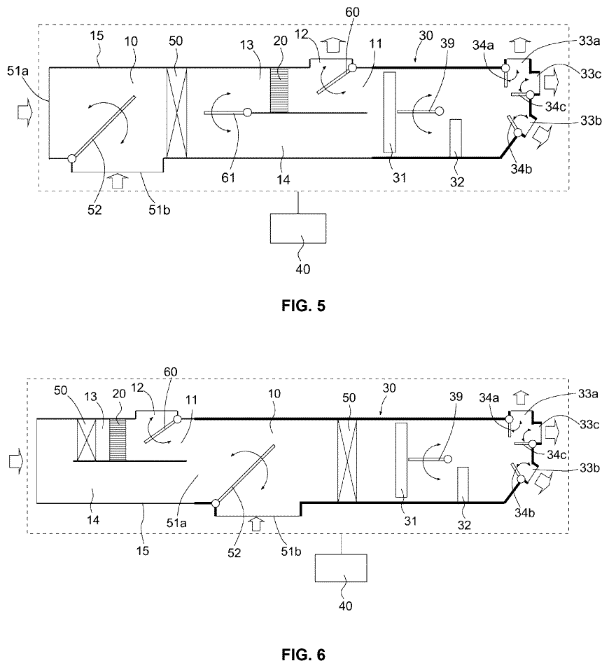

The air conditioning system illustrated in FIGS. 3 and 5 preferably further includes a second valve 61 capable of switching the flow of the air between the third flow path 13 and the fourth flow path 14 on an upstream side of the air conditioning device 20. The second valve 61 allows the air to selectively flow through the third flow path 13 or the fourth flow path 14. In this case, the ventilation fan 50 may be provided on an upstream side of the second valve 61, as illustrated in FIGS. 3 and 5.

### (2. Air Conditioning Device 20)

The air conditioning device 20 is provided in the flow path 10.

The air conditioning device 20 can execute an adsorption mode in which the adsorption target substance is adsorbed and a regeneration mode in which the adsorption target substance is desorbed.

The air conditioning device 20 includes a substrate portion that can be heated by application of voltage, and an adsorption portion containing an adsorbent capable of adsorbing and desorbing the adsorption target substance. The air conditioning device 20 having such a structure allows the adsorption mode and the regeneration mode to be easily achieved.

Also, the number of air conditioning devices 20 provided in the flow path 10 may be one or more than one. When more than one air conditioning devices 20 are provided, they may be arranged in parallel to or in series with the flow of the air flowing through the flow path 10.

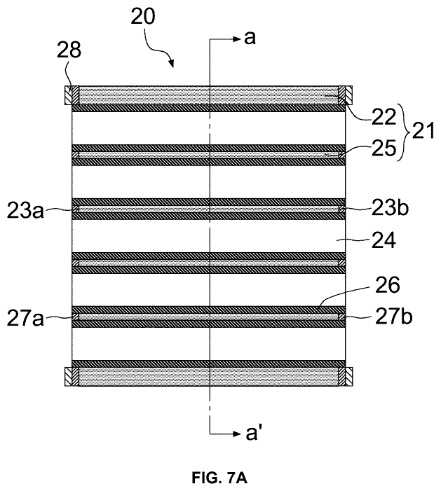

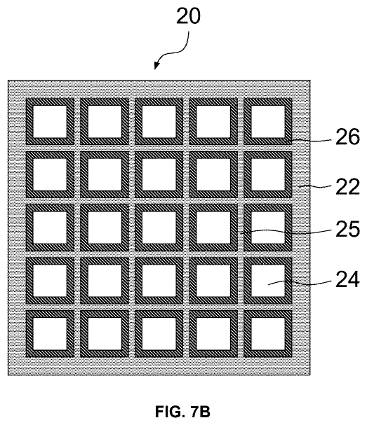

FIG. 7A is a schematic view of a cross section of a typical air conditioning device used in an air conditioning system according to Embodiment 1, which is parallel to a flow path direction; FIG. 7B is a schematic cross-sectional view of the air conditioning device in FIG. 7A taken along the line a-a′.

The air conditioning device 20 as illustrated in FIGS. 7A and 7B includes: a honeycomb structure 21 having an outer peripheral wall 22 and partition walls 25 provided on an inner side of the outer peripheral wall 22, the partition walls 25 defining a plurality of cells 24 each extending from a first end face 23a to a second end face 23b of the honeycomb structure 21 to form a flow path for air; an adsorbing layer 26 containing an adsorbent, the adsorbing layer 16 being provided on a surface of each of the partition walls 15; and a pair of electrodes 27a, 27b provided on the first end face 23a and the second end face 23b of the honeycomb structure 11. Although not illustrated, the pair of electrodes 27a, 27b may be provided on the outer peripheral wall 22 parallel to the extending direction of the cells 24 of the honeycomb structure 21. Also, terminals 28 may be connected to the pair of electrodes 27a, 27b, respectively.

In addition, the pair of electrodes 27a, 27b can be electrically connected to the control unit 40 via a power source (not shown). Therefore, the air conditioning device 20 can adjust the state of the voltage applied to the pair of electrodes 27a, 27b according to instructions from the control unit 40. The power source is not particularly limited, and a battery or the like can be used.

### (2-1. Honeycomb Structure 21)

The shape of the honeycomb structure 21 is not particularly limited. For example, an outer shape of a cross section of the honeycomb structure 21 orthogonal to the flow path direction (extending direction of the cells 24) can be polygonal such as quadrangular (rectangular, square), pentagonal, hexagonal, heptagonal, and octagonal, circular, oval (egg-shaped, elongated circular, elliptical, rounded rectangular, etc.), or the like. The end faces (first end face 23a and second end face 23b) have the same shape as the cross section. Also, when the cross section and the end faces are polygonal, the corners may be chamfered.

The shape of each cell 24 is not particularly limited, but it may be polygonal such as quadrangular (rectangular, square), pentagonal, hexagonal, heptagonal, and octagonal, circular, or oval in the cross section of the honeycomb structure 21 orthogonal to the flow path direction. These shapes may be alone or in combination of two or more. Moreover, among these shapes, the quadrangle or the hexagon is preferable. By providing the cells 24 having such a shape, it is possible to reduce the pressure loss when the air flows.

The honeycomb structure 21 may be a honeycomb joined body that includes a plurality of honeycomb segments and joining layers that join outer peripheral side surfaces of the plurality of honeycomb segments together. The use of the honeycomb joined body can increase the total cross-sectional area of the cells 24, which is important for ensuring the flow rate (flow velocity) of the air, while suppressing cracking.

It should be noted that the joining layer can be formed by using a joining material. The joining material is not particularly limited, but a ceramic material obtained by adding a solvent such as water to form a paste can be used. The joining material may contain a material having a PTC property, or may contain the same material as the outer peripheral wall 22 and the partition walls 25. In addition to the role of joining the honeycomb segments to each other, the joining material can also be used as an outer peripheral coating material after joining the honeycomb segments.

From the viewpoints of ensuring the strength of the honeycomb structure 21, reducing a pressure loss when the air passes through the cells 24, ensuring the amount of the adsorbent supported, and ensuring the contact area with the air flowing inside the cells 24, it is desirable to suitably combine a thickness of the partition wall 25, a cell density, and a cell pitch (or an opening ratio of the cells 24).

As used herein, the cell density refers a value obtained by dividing a number of cells by an area of one end face (first end face 23a or second end face 23b) of the honeycomb structure 21 (the total area of the partition walls 25 and the cells 24 excluding the outer peripheral wall 22).

As used herein, the cell pitch refers to a value obtained by the following calculation. First, the area of one end face (first end face 23a or second end face 23b) of the honeycomb structure 21 (the total area of the partition walls 25 and the cells 24 excluding the outer peripheral wall 22) is divided by the number of the cells to calculate an area per a cell. A square root of the area per a cell is then calculated, and this is determined to be the cell pitch.

As used herein, the opening ratio of the cells 24 refers a value obtained by dividing the total area of the cells 24 defined by the partition walls 25 by the area of one end face (first end face 23a or second end face 23b) (the total area of the partition walls 25 and the cells 24 excluding the outer peripheral wall 22) in the cross section orthogonal to the flow path direction of the honeycomb structure 21. It should be noted that when calculating the opening ratio of the cells 24, the pair of electrodes 27a, 27b, and the adsorbing layer 26 are not taken into account.

In an embodiment that is advantageous from the viewpoint of supporting a sufficient amount of functional material, the thickness of the partition walls 25 is 0.300 mm or less, the cell density is 100 cells/cm² or less, and the cell pitch is 1.0 mm or more. In a preferred embodiment, the thickness of the partition walls 25 is 0.200 mm or less, the cell density is 70 cells/cm² or less, and the cell pitch is 1.2 mm or more. In a more preferred embodiment, the thickness of the partition walls 25 is 0.130 mm or less, the cell density is 65 cells/cm² or less, and the cell pitch is 1.3 mm or more.

From the viewpoints of ensuring the strength of the honeycomb structure 21 and maintaining lower electrical resistance, the lower limit of the thickness of the partition wall 25 is preferably 0.010 mm or more, more preferably 0.020 mm or more, and even more preferably 0.030 mm or more.

From the viewpoints of ensuring the strength of the honeycomb structure 21, maintaining lower electrical resistance, and increasing a surface area to facilitate reaction, adsorption, and desorption, the lower limit of the cell density is 30 cells/cm² or more, and preferably 35 cells/cm² or more, and even more preferably 40 cells/cm² or more.

From the viewpoints of ensuring the strength of the honeycomb structure 21, maintaining lower electrical resistance and increasing a surface area to facilitate reaction, adsorption and separation, the upper limit of the cell pitch is 2.0 mm or less, more preferably 1.8 mm or less, and even more preferably 1.6 mm or less.

In an embodiment that is advantageous in terms of both reducing pressure loss and maintaining strength, the thickness of the partition walls 25 is 0.08 to 0.36 mm, the cell density is 2.54 to 140 cells/cm², and the opening ratio of the cells 24 is 0.70 or more. In a preferred embodiment, the thickness of the partition walls 25 is 0.09 to 0.35 mm, the cell density is 15 to 100 cells/cm², and the opening ratio of the cells 24 is 0.80 or more. In a more preferred embodiment, the thickness of the partition walls 25 is 0.14 to 0.30 mm, the cell density is 20 to 90 cells/cm², and the opening ratio of the cells 24 is 0.85 or more.

From the viewpoint of ensuring the strength of the honeycomb structure 21, the upper limit of the opening ratio of the cells 24 is preferably 0.94 or less, more preferably 0.92 or less, and even more preferably 0.90 or less.

Although the thickness of the outer peripheral wall 22 is not particularly limited, it is preferably determined based on the following considerations. First, from the viewpoint of reinforcing the honeycomb structure 21, the thickness of the outer peripheral wall 22 is preferably 0.05 mm or more, more preferably 0.06 mm or more, and even more preferably 0.08 mm or more. On the other hand, when the viewpoint of suppressing the initial current by increasing the electrical resistance and from the viewpoint of reducing pressure loss when air flows are considered, the thickness of the outer peripheral wall 22 is preferably 1.0 mm or less, more preferably 0.5 mm, even more preferably 0.4 mm or less, and still more preferably 0.3 mm or less.

As used herein, the thickness of the outer peripheral wall 22 refers to a length, in a normal line direction of a side surface of the honeycomb structure 21, from a boundary between the outer peripheral wall 22 and the outermost cell 24 or the partition wall 25 to the side surface of the honeycomb structure 21 in the cross section orthogonal to the flow path direction of the honeycomb structure 11.

The length of the honeycomb structure 21 in the flow path direction and the cross-sectional area of the honeycomb structure 11 orthogonal to the flow path direction may be adjusted according to the required size of the air conditioning device 20, and are not particularly limited. For example, when used in a compact air conditioning device 20 while ensuring a predetermined function, the honeycomb structure 21 can have a length of 2 to 20 mm in the flow path direction and a cross-sectional area of 10 cm² or more orthogonal to the flow path direction. Although the upper limit of the cross-sectional area orthogonal to the flow path direction of the honeycomb structure 21 is not particularly limited, it is, for example, 300 cm² or less.

The partition walls 25 forming the honeycomb structure 21 are preferably made of a material that can be heated by electric conduction, specifically made of a material having a PTC property. Further, the outer peripheral wall 22 may also be made of a material having a PTC property, as with the partition walls 25, as needed. By such a configuration, the adsorbing layer 26 can be directly heated by heat transfer from the heat-generating partition walls 25 (and optionally the outer peripheral wall 22). Further, the material having the PTC property has characteristics such that when the temperature increases to exceed the Curie point, the resistance value is sharply increased, making it difficult for electricity to flow. Therefore, when the temperature of the partition walls 25 (and the outer peripheral wall 22 if necessary) becomes high, the current flowing through them is limited, thereby suppressing excessive heat generation of the honeycomb structure 21. Therefore, it is possible to suppress thermal deterioration of the adsorbing layer 26 due to excessive heat generation.

From the viewpoint of obtaining appropriate heat generation, the lower limit of the volume resistivity at 25° C. of the material having the PTC property is preferably 0.5 Ω·cm or more, and more preferably 1 Ω·cm or more, and even more preferably 5 Ω·cm or more. From the viewpoint of generating heat with a low driving voltage, the upper limit of the volume resistivity at 25° C. of the material having the PTC property is preferably 30 Ω·cm or less, and more preferably 18 Ω·cm or less, and even more preferably 16 Ω·cm or less. As used herein, the volume resistivity at 25° C. of the material having the PTC property is measured according to JIS K 6271:2008.

From the viewpoints that can be heated by electric conduction and has the PTC property, the outer peripheral wall 22 and the partition walls 25 are preferably made of a material containing barium titanate (BaTiO₃) as a main component. Also, this material is more preferably ceramics made of a material containing barium titanate (BaTiO₃)-based crystals as a main component in which a part of Ba is substituted with a rare earth element. As used herein, the term “main component” means a component in which a proportion of the component is more than 50% by mass of the total component. The content of BaTiO₃-based crystalline particles can be determined by fluorescent X-ray analysis. Other crystalline particles can be measured in the same manner as this method.

The compositional formula of BaTiO₃-based crystalline particles, in which a part of Ba is substituted with the rare earth element, can be expressed as (Ba₁₋ₓAₓ)TiO₃. In the compositional formula, the symbol A represents at least one rare earth element, and 0.001≤x≤0.010.

The symbol A is not particularly limited as long as it is the rare earth element, but it may preferably be one or more selected from the group consisting of La, Ce, Pr, Nd, Eu, Gd, Dy, Ho, Er, Y and Yb, and more preferably La. The x value is preferably 0.001 or more, and more preferably 0.0015 or more, in terms of suppressing excessively high electrical resistance at room temperature. On the other hand, x is preferably 0.009 or less, in terms of preventing the electrical resistance at room temperature from becoming too high due to insufficient sintering.

The content of the BaTiO₃-based crystalline particles in which a part of Ba is substituted with the rare earth element in the ceramics is not particularly limited as long as it is determined to be the main component, but it may preferably be 90% by mass or more, and more preferably 92% by mass or more, and even more preferably 94% by mass or more. The upper limit of the content of the BaTiO₃-based crystalline particles is not particularly limited, but it may generally be 99% by mass, and preferably 98% by mass.

In terms of reduction of the environmental load, it is desirable that the materials used for the outer peripheral wall 22 and the partition walls 25 are substantially free of lead (Pb). Specifically, the outer peripheral wall 22 and the partition walls 25 preferably have a Pb content of 0.01% by mass or less, and more preferably 0.001% by mass or less, and still more preferably 0% by mass. The lower Pb content can allow the air heated by contact with the heat-generating partition walls 25 or the like to be safely applied to organisms such as humans, for example. In the outer peripheral wall 22 and the partition walls 25, the Pb content is preferably less than 0.03% by mass, more preferably less than 0.01% by mass, and even more preferably 0% by mass, as converted to PbO. The lead content can be determined by ICP-MS (inductively coupled plasma mass spectrometry).

The Curie point of the material making up the outer peripheral wall 22 and the partition walls 25 is preferably in a temperature range where the resistance value is twice or more the resistance at room temperature (25° C.). If the Curie point is in such a temperature range, the current flowing through the air conditioning device 20 will be limited when the temperature of the air conditioning device 20 becomes high, so that any excessive heat generation of the air conditioning device 20 will be efficiently suppressed. Therefore, thermal deterioration of the adsorbing layer 26 caused by excessive heat generation can be suppressed.

In terms of efficiently heating the adsorbing layer 26, the material making up the outer peripheral wall 22 and the partition walls 25 preferably have a lower limit of a Curie point of 80° C. or more, more preferably 100° C. or more, even more preferably 110° C. or more, and still more preferably 125° C. or more. Further, in terms of safety as a component placed in the vehicle interior or near the vehicle interior, the upper limit of the Curie point is preferably 200° C. or more, more preferably 190° C. or more, even more preferably 180° C. or more, and still more preferably 150° C. or more.

The Curie point of the material making up the outer peripheral wall 22 and the partition walls 25 can be adjusted by the type and amount of shifter added. For example, the Curie point of barium titanate (BaTIO₃) is about 120° C., but the Curie point can be shifted to the lower temperature side by substituting a part of Ba and Ti with one or more of Sr, Sn and Zr.

As used herein, the Curie point is measured by the following method. A sample is attached to a sample holder for measurement, mounted in a measuring tank (e.g., MINI-SUBZERO MC-810P, from ESPEC). A change in electrical resistance of the sample as a function of a temperature when the temperature is increased from 10° C. is measured using a DC resistance meter (e.g., Multimeter 3478A, from JAPAN HEWLETT PACKARD, LLC). Based on an electrical resistance-temperature plot obtained by the measurement, a temperature at which the resistance value is twice the resistance value at room temperature (25° C.) is defined as the Curie point.

### (2-2. Adsorbing Layer 26)

The adsorbing layer 26 contains an adsorbent.

The adsorbing layer 26 can be provided on the surfaces of the partition walls 25 (in the case of the outermost cells 24, the partition walls 25 that define the outermost cells 24 and the outer peripheral wall 22). By thus providing the adsorbing layer 26, the adsorption target substance is easily adsorbed during the adsorption mode, and the adsorbing layer 26 can be easily heated during the regeneration mode, so that the adsorption target substance can easily be separated from the adsorbing layer 26.

The adsorbing layer 26 is capable of adsorbing and separating the adsorption target substance.

The adsorption target substance is not particularly limited, but it may preferably be moisture, carbon dioxide, or volatile components, and more preferably moisture. Therefore, for example, the adsorbing layer 26 can contain at least one adsorbent that can adsorb these components. If one adsorbent can adsorb all the moisture, carbon dioxide and volatile components, the moisture, the carbon dioxide and the volatile components can be adsorbed by including only that adsorbent. By containing such an adsorbent, it is possible to obtain an effect of purifying the air.

The adsorbent contained in the adsorbing layer 26 preferably has a function that can adsorb the adsorption target substance at −20 to 40° C. and desorb it at an elevated temperature of 60° C. or more.

Examples of the adsorbent include, but not limited to, aluminosilicate, silica gel, silica, graphene oxide, polymer adsorbents, polystyrene sulfonic acid, zeolite, activated carbon, alumina, low-crystalline clay, amorphous aluminum silicate composites, and metal organic frameworks (MOFs). These may be used alone or in combination of two or more.

Examples of the aluminosilicate that can be preferably used herein include AFI type-, CHA type-, or BEA type-zeolite; porous clay minerals such as allophane and imogolite. Also, it is more preferable that the aluminosilicate is amorphous.

As the silica gel, type A silica gel is preferably used.

Examples of the polymer adsorbent that can be preferably used herein include a polymer adsorbent having a polyacrylic acid polymer chain. For example, sodium polyacrylate or the like can be used as the polymer adsorbent.

The metal organic framework is a crystalline hybrid material containing metal ions and organic molecules (organic ligands). The metal ions are preferably hydrophilic metal ions (for example, aluminum ions).

The volatile components in the air in the room interior are, for example, volatile organic compounds (VOCs), odor components other than the VOCs, and the like. Specific examples of the volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, and di-2-ethylhexyl phthalate, diazinon, acetaldehyde, 2-(1-methylpropyl)phenyl N-methylcarbamate, and the like.

The adsorbing layer 26 can contain a catalyst. By containing the catalyst, it is possible to promote oxidation-reduction reaction and the like to purify carbon dioxide and/or volatile components. The catalyst having such a function includes metal catalysts such as Pt, Pd and Ag, and oxide catalysts such as CeO₂ and ZrO₂. The catalyst may be used alone or in combination of two or more types. The catalyst may also be used in combination with the functional material as described above.

The thickness of the adsorbing layer 26 may be determined according to the size of the cells 24, and is not particularly limited. For example, from the viewpoint of ensuring sufficient contact with air, the thickness of the adsorbing layer 26 is preferably 20 μm or more, more preferably 25 μm or more, and even more preferably 30 μm or more. On the other hand, from the viewpoint of suppressing separation of the adsorbing layer 26 from the partition walls 25 and the outer peripheral wall 22, the thickness of the adsorbing layer 26 is preferably 400 μm or less, more preferably 380 μm or less, and even more preferably 350 μm or less.

The thickness of the adsorbing layer 26 is measured using the following procedure. Any cross section of the honeycomb structure 21 parallel to the flow path direction is cut out, and a cross-sectional image at magnifications of about 50 is acquired using a scanning electron microscope or the like. Also, this cross section is made to pass through the center of gravity position in the cross section orthogonal to the flow path of the honeycomb structure 21. The thickness of each adsorbing layer 26 visually recognized from the cross-sectional image is calculated by dividing the cross-sectional area by the length of the cells 24 in the flow path direction. This calculation is performed for all the adsorbing layers 26 visually recognized from the cross-sectional image, and an average value thereof is determined to be the thickness of the adsorbing layer 26.

From the viewpoint of exerting a desired function in the air conditioning device 20, an amount of the adsorbing layer 26 is preferably 50 to 500 g/L, more preferably 100 to 400 g/L, and even more preferably 150 to 350 g/L, based on the volume of the honeycomb structure 21. It should be noted that the volume of the honeycomb structure 21 is a value determined by the external dimensions of the honeycomb structure 21.

In the regeneration mode of the adsorbing layer 26, the adsorbing layer 26 is preferably heated at a temperature higher than or equal to the separating temperature depending on the type of the adsorbent in order to promote the separation of the adsorption target substance captured by the adsorbing layer 26. For example, it is more preferable to heat the adsorbing layer 26 at 70 to 150° C., even more preferably 80 to 140° C., and still more preferably 90 to 130° C.

### (2-3. Pair of Electrodes 27a, 27b)

A pair of electrodes 27a, 27b may be provided on the first end face 23a and the second end face 23b as illustrated in FIG. 7A, although the positions of the electrodes 27a, 27b are not limited thereto. Also, the pair of electrodes 27a, 27b may be provided on the outer peripheral wall 22 parallel to the extending direction of the cells 24 of the honeycomb structure 21.

Applying of a voltage between the pair of electrodes 27a, 27b allows the honeycomb structure 21 to generate heat by Joule heat.

The pair of electrodes 27a, 27b may employ, for example, a metal or alloy containing at least one selected from Cu, Ag, Al, Ni and Si, although not particularly limited thereto. It is also possible to use an ohmic electrode capable of ohmic contact with the outer peripheral wall 22 and/or the partition walls 25 which have the PTC property. The ohmic electrode may employ an ohmic electrode containing, for example, at least one selected from Al, Au, Ag and In as a base metal, and containing at least one selected from Ni, Si, Zn, Ge, Sn, Se and Te for n-type semiconductors as a dopant. Further, the pair of electrodes 27a, 27b may have a single-layer structure, or may have a laminated structure of two or more layers. When the pair of electrodes 27a, 27b have the laminated structure of two or more layers, the materials of the respective layers may be of the same type or of different types.

The thickness of the pair of electrodes 27a, 27b may be appropriately set according to the method for forming the pair of electrodes 27a, 27b. The method for forming the pair of electrodes 27a, 27b includes metal deposition methods such as sputtering, vapor deposition, electrolytic deposition, and chemical deposition. Alternatively, the pair of electrodes 27a, 27b can be formed by applying an electrode paste and then baking it, or by thermal spraying. Furthermore, the pair of electrodes 27a, 27b may be formed by joining metal sheets or alloy sheets.

Each of the thicknesses of the pair of electrodes 27a, 27b is, for example, about 5 to 80 μm for baking the electrode paste, and about 100 to 1000 nm for dry plating such as sputtering and vapor deposition, and about 10 to 100 μm for thermal spraying, and about 5 μm to 30 μm for wet plating such as electrolytic deposition and chemical deposition. Further, when joining the metal sheet or alloy sheet, each thickness is preferably about 5 to 100 μm.

### (2-4. Terminal 28)

The terminals 28 are connected to the pair of electrodes 27a, 27b and provided on at least a part of the pair of electrodes 27a, 27b. The provision of the terminals 28 facilitates connection to an external power supply. The terminals 28 are connected to a conductor connected to the external power supply.

The terminals 28 may be made of any material, including, but not particularly limited to, a metal, for example. The metal that can be used herein may include single metals, alloys, and the like, but from the viewpoint of corrosion resistance, electrical resistivity, and coefficient of linear expansion, it may preferably be alloys containing at least one selected from the group consisting of Cr, Fe, Co, Ni, Cu, Al, and Ti, and more preferably stainless steel, Fe—Ni alloy, and phosphor bronze.

The size and shape of the terminal 28 are not particularly limited. For example, as illustrated in FIG. 7A, the terminals 28 can be provided on the whole of the pair of electrodes 27a, 27b on the outer peripheral wall 22. Further, the terminals 28 may be provided on a part of the pair of electrodes 27a, 27b on the outer peripheral wall 22, or may be provided so as to extend toward an outer side than the outer edge of each of the pair of electrodes 27a, 27b on the outer peripheral wall 22. Further, the terminals 28 may be provided on a part of the pair of electrodes 27a, 27b on the partition walls 25, or may be provided so as to block a part of the cells 24.

Furthermore, the thickness of the terminal 28 is not particularly limited, but it is, for example, 0.01 to 10 mm, typically 0.05 to 5 mm.

The method of connecting the terminals 28 to the pair of electrodes 27a, 27b is not particularly limited as long as they are electrically connected. For example, they can be connected by diffusion bonding, a mechanical pressing mechanism, welding, or the like.

### (2-5. Method for Producing Air Conditioning Device 20)

The method for producing the air conditioning device 20 according to the embodiment of the present invention is not particularly limited, and it can be performed according to a known method. Hereinafter, the method for producing the air conditioning device 20 according to an embodiment of the present invention will be illustratively described.

A method for producing the honeycomb structure 21 forming the air conditioning device 20 includes a forming step and a firing step.

In the forming step, a green body containing a ceramic raw material including BaCO₃ powder, TiO₂ powder, and rare earth nitrate or hydroxide powder is formed to prepare a honeycomb formed body having a relative density of 60% or more.

The ceramic raw material can be obtained by dry-mixing the powders so as to have a desired composition.

The green body can be obtained by adding a dispersion medium, a binder, a plasticizer and a dispersant to the ceramic raw material and kneading them together. The green body may optionally contain additives such as shifters, metal oxides, property improving agents, and conductor powder.

The blending amount of the components other than the ceramic raw material is not particularly limited as long as the relative density of the honeycomb formed body is 60% or more.

As used herein, the “relative density of the honeycomb formed body” means a ratio of the density of the honeycomb formed body to the true density of the entire ceramic raw material. More particularly, the relative density can be determined by the following equation:

relative density of honeycomb formed body (%)=density of honeycomb formed body (g/cm³)/true density of entire ceramic raw material (g/cm³)×100.

The density of the honeycomb formed body can be measured by the Archimedes method using pure water as a medium. Further, the true density of the entire ceramic raw material can be obtained by dividing the total mass of the respective raw materials (g) by the total volume of the actual volumes of the respective raw materials (cm³).

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. The binder may be used alone, or in combination of two or more, but it is preferable that the binder does not contain an alkali metal element.

Examples of the plasticizer include polyoxyalkylene alkyl ethers, polycarboxylic acid-based polymers, and alkyl phosphate esters.

The dispersant that can be used herein includes surfactants such as polyoxyalkylene alkyl ether, ethylene glycol, dextrin, fatty acid soaps, and polyalcohol. The dispersant may be used alone or in combination of two or more.

The honeycomb formed body can be produced by extruding the green body. For the extrusion, a die having a desired overall shape, cell shape, partition wall thickness, cell density and the like can be used.

The relative density of the honeycomb formed body obtained by extrusion is 60% or more, and preferably 65% or more. By limiting the relative density of the honeycomb formed body to such a range, the honeycomb formed body can be densified and the electrical resistance at room temperature can be reduced. The upper limit of the relative density of the honeycomb formed body is not particularly limited, but it may generally be 80%, and preferably 75%.

The honeycomb formed body can be dried before the firing step. Non-limiting examples of the drying method include known drying methods such as hot air drying, microwave drying, dielectric drying, drying under reduced pressure, drying in vacuum, and freeze drying. Among these, a drying method that combines the hot air drying with the microwave drying or dielectric drying is preferable because the entire formed body can be rapidly and uniformly dried.

The firing step includes maintaining the formed body at a temperature of from 1150 to 1250° C., and then increasing the temperature to a maximum temperature of from 1360 to 1430° C. at a heating rate of 20 to 600° C./hour, and maintaining the temperature for 0.5 to 10 hours.

The maintaining of the honeycomb formed body at the maximum temperature of from 1360 to 1430° C. for 0.5 to 10 hours can provide the honeycomb structure 21 containing, as a main component, BaTiO₃-based crystal particles in which a part of Ba is substituted with the rare earth element.

Further, the maintaining at the temperature of from 1150 to 1250° C. can allow the Ba₂TiO₄ crystal particles generated in the firing process to be easily removed, so that the honeycomb structure 21 can be densified.

Further, the heating rate of 20 to 600° C./hour from the temperature of 1150 to 1250° C. to the maximum temperature of 1360 to 1430° C. can allow 1.0 to 10.0% by mass of Ba₆Ti₁₇O₄₀ crystal particles to be formed in the honeycomb structure 21.

The amount of time when the honeycomb formed body is maintained at 1150 to 1250° C. is not particularly limited, but it may preferably be from 0.5 to 10 hours. Such a maintaining time can lead to stable and easy removal of Ba₂TiO₄ crystal particles generated in the firing process.

The firing step preferably includes maintaining the honeycomb formed body at 900 to 950° C. for 0.5 to 5 hours while the temperature is increased. The maintaining at 900 to 950° C. for 0.5 to 5 hours can lead to sufficient decomposition of BaCO₃, so that the honeycomb structure 21 having a predetermined composition can be easily obtained.

Prior to the firing step, a degreasing step for removing the binder may be performed. The degreasing step may preferably be performed in an air atmosphere in order to decompose the organic components completely.

Also, the atmosphere of the firing step may preferably be the air atmosphere in terms of control of electrical characteristics and production cost.

A firing furnace used in the firing step and the degreasing step is not particularly limited, but it may be an electric furnace, a gas furnace, or the like.

On the honeycomb structure 21 thus obtained, the pair of electrodes 27a, 27b are formed. The pair of electrodes 27a, 27b can be formed by metal deposition methods such as sputtering, vapor deposition, electrolytic deposition, and chemical deposition. Further, the pair of electrodes 27a, 27b can also be formed by applying an electrode paste and then baking it. Furthermore, the pair of electrodes 27a, 27b can also be formed by thermal spraying. The pair of electrodes 27a, 27b may be composed of a single layer, but may also be composed of a plurality of electrode layers having different compositions. A typical method for forming the pair of electrodes 27a, 27b will be described below.

First, an electrode slurry containing an electrode material, an organic binder, and a dispersion medium is prepared, and the first end face 23a or the second end face 23b of the honeycomb structure 21 is coated with the slurry. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. An excess slurry on the periphery of the honeycomb structure 21 is removed by blowing and wiping. The slurry can be then dried to form the pair of electrodes 27a, 27b on the first end face 24a or the second end face 23b of the honeycomb structure 21. The drying can be performed while heating the honeycomb structure 21 to a temperature of about 120 to 600° C., for example. Although a series of steps of coating, slurry removal, and drying may be performed only once, the steps can be repeated multiple times to provide the pair of electrodes 27a, 27b having desired thicknesses.

The terminals 28 are then provided at predetermined positions of the pair of electrodes 27a, 27b, and the pair of electrodes 27a, 27b and the terminals 28 are connected to each other. As a method of connecting the pair of electrodes 27a, 27b to the terminals 28, the method described above can be used.

It should be noted that the terminals 28 may be placed after forming an adsorbing layer 26 described below.

The adsorbing layer 26 is then formed on the surfaces of the partition walls 25 and the like of the honeycomb structure 21.

Although the method for forming the adsorbing layer 26 is not particularly limited, it can be formed, for example, by the following steps. The honeycomb structure 21 is immersed in a slurry containing an adsorbent, a binder, and a dispersion medium for a predetermined period of time, and an excess slurry on the end faces and the outer periphery of the honeycomb structure 21 is removed by blowing and wiping. The binder may be an organic binder or an inorganic binder, or a combination thereof. The dispersion medium can be water, an organic solvent (e.g., toluene, xylene, ethanol, n-butanol, ethyl acetate, butyl acetate, terpineol, dihydroterpineol, texanol, ethylene glycol monobutyl ether acetate, diethylene glycol monoethyl ether acetate, diethylene glycol monoethyl ether, diethylene glycol monobutyl ether acetate, diethylene glycol monobutyl ether) or a mixture thereof. The slurry can be then dried to form the adsorbing layer 26 on the surfaces of the partition walls 25 and the like. The drying can be performed while heating the honeycomb structure 21 to a temperature of about 120 to 600° C., for example. Although a series of steps of immersion, slurry removal, and drying may be performed only once, the steps can be repeated multiple times to provide the adsorbing layer 26 having the desired thickness on the surfaces of the partition walls 25 and the like.

### (2-6. Other Air Conditioning Device 20)

The air conditioning device 20 has a flow path for the air and a flow path for a heating medium adjacent to the flow path for the air, and the adsorption portion is provided in the flow path for the air. The air conditioning device 20 having such a structure includes a plate-fin type heat exchanger provided with a plurality of fins on a pipe and an aerofin type heat exchanger having the adsorbing layer 26 on each surface of the fins.

In the air conditioning device 20 having the above structure, the air flows between the fins and the heating medium flows through the pipe. The fins are heated by the flow of the heating medium, so that the adsorbing layer 26 provided on each surface of the fins can be heated.

The air conditioning device 20 having the structure as described above can be produced by using a commercially available plate fin type heat exchanger or aerofin type heat exchanger to form the adsorbing layer 26 on the surfaces of the fins. The adsorbing layer 26 may be formed by the method as described above.

The air conditioning device 20 may include: a honeycomb structure 21 having an outer peripheral wall 22 and partition walls 25 provided on an inner side of the outer peripheral wall 22, the partition walls 25 defining a plurality of cells 24 each extending from a first end face 23a to a second end face 23b of the honeycomb structure 21 to form a flow path for air; an adsorbing layer 26 containing an adsorbent, the adsorbing layer 27 being provided on a surface of each of the partition walls 26; and a heater provided on an upstream side of the honeycomb structure 21. It should be noted that the structure of the air conditioning device 20 corresponds to the structure in which the pair of electrodes 28a, 27b and the terminals 28 are removed in FIG. 7A.

In the air conditioning device 20 having the heating structure as described above, the adsorbing layer 26 provided on each surface of the partition walls 25 can be heated by allowing the air heated by the heater to flow through the cells 24 of the honeycomb structure 21.

The air conditioning device 20 having the heating structure as described above can be formed from various materials such as metals and ceramics, because the honeycomb structure 21 itself is not required to generate heat by electrical conduction. The honeycomb structure 21 may be made of a material that can be heated by electrical conduction.

The air conditioning device 20 having the heating structure as described above can be produced according to the method as described above.

### (3. HVAC Unit 30)

The HVAC unit 30 may include an evaporator 31 for performing cooling and dehumidification of the air flowing through the HVAC unit 30.

Also, the HVAC unit 30 may include a condenser 32 for heating the air flowing through the HVAC unit 30. Although the position of the condenser 32 is not particularly limited, it can be provided in the flow path 10 on a downstream side of the evaporator 31, for example.

The HVAC unit 30 includes a defroster opening 33a, a foot opening 33b, and a face opening 33c, which are opened toward the vehicle interior on a downstream side of the evaporator 31 and the condenser 32. It also includes a defroster door 34a for adjusting an amount of air blowing out from the defroster opening 33a, a foot door 34b for adjusting an amount of air blowing out from the foot opening 33b, and a face door 34c for adjusting an amount of air blowing out from the face opening 33c.

In the case of the air conditioning system illustrated in FIGS. 2, 3 and 6, the HVAC unit 30 can include a ventilation fan 50 (blower). Specifically, in the case of the air conditioning system illustrated in FIG. 2, the HVAC unit 30 can include the ventilation fan 50 in each of the third flow path 13 that is provided with the air conditioning device 20 and the fourth flow path 14 that is not provided with the air conditioning device 20. In the case of the air conditioning system illustrated in FIG. 3, the HVAC unit 30 can include the ventilation fan 50 in the flow path 10 on an upstream side of the third flow path 13 and the fourth flow path 14. In the case of the air conditioning system illustrated in FIG. 6, the HVAC unit 30 can include the ventilation fan 50 in the flow path 10 on an upstream side of the evaporator 31.

In addition, the ventilation fan 50 is not particularly limited, and any known ventilation fan can be used.

On the other hand, in the case of the air conditioning system illustrated in FIGS. 4 and 5, the ventilation fan 50 is provided in the flow path 10 in a duct 15 that is different from that of the HVAC unit 30. In the case of the air conditioning system illustrated in FIG. 6, in addition to the HVAC unit 30, the ventilation fan 50 is also provided in the flow path 10 in the duct 15. Specifically, in the case of the air conditioning system illustrated in FIG. 4, in the flow path 10 in the duct 15 on the upstream side of the HVAC unit 30, the ventilation fan 50 can be included in each of the third flow path 13 that is provided with the air conditioning device 20 and the fourth flow path 14 that is not provided with the air conditioning device 20. Also, in the case of the air conditioning system illustrated in FIG. 5, in the flow path 10 in the duct 15 on the upstream side of the HVAC unit 30, the ventilation fan 50 can be included in the flow path 10 on the upstream side of the third flow path 13 and the fourth flow path 14. In the case of the air conditioning system illustrated in FIG. 6, the ventilation fan 50 can be included in the third flow path 13 on the upstream side of the air conditioning device 20.

In the case of the air conditioning system illustrated in FIGS. 2, 3 and 6, the HVAC unit 30 can include an inside air feed port 51a for feeding the inside air, an outside air feed port 51b for feeding the outside air, and a damper 52 for adjusting flow rates of the inside air and the outside air.

On the other hand, in the case of the air conditioning system illustrated in FIGS. 4 and 5, the duct 15 on the upstream side of the HVAC unit 30 can include an inside air feed port 51a for feeding the inside air, an outside air feed port 51b for feeding the outside air, and a damper 52 for adjusting flow rates of the inside air and the outside air.

The HVAC unit 30 may include an air mix door 39 between the evaporator 31 and the condenser 32.

The air mix door 39 is configured to be rotated in the flow path 10 in the HVAC unit 30 between a heating position that opens a heating path toward the condenser 32 and a cooling position that opens a cooling path that bypasses the condenser 32. Furthermore, by rotating the air mix door 39 between the heating position and the cooling position, it can adjust a ratio of the air passing through the condenser 32 to the air bypassing the condenser 32, thereby adjusting the temperature of the air flowing into the vehicle interior.

The evaporator 31 and the condenser 32 of the HVAC unit 30 can be connected to the heat pump cycle.

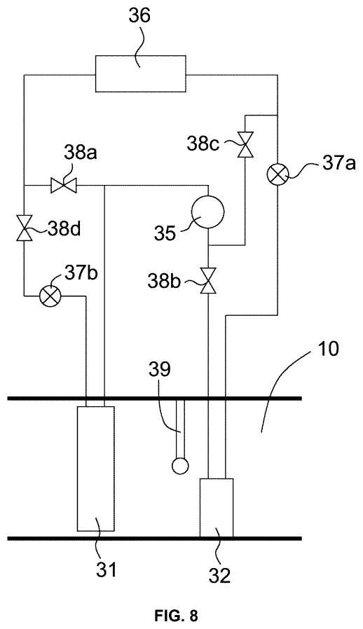

Here, FIG. 8 illustrates a schematic view of the heat pump cycle connected to the evaporator 31 and the condenser 32.

In the heat pump cycle, the evaporator 31 can exchange heat between the cold of the refrigerant and the air. Specifically, the evaporator 31 is capable of absorbing the heat by a low-temperature, low-pressure refrigerant flowing through the heat pump cycle, and cools the air in the flow path, which passes around the evaporator 31. The condenser 32 can also exchange heat between the refrigerant and the air. Specifically, the condenser 32 is capable of dissipating the heat by a high-temperature, high-pressure refrigerant flowing through the heat pump cycle, and heats the air in the flow path 10, which passes around the condenser 32.

The heat pump cycle can further include: a compressor 35; an outdoor heat exchanger 36; expansion valves 37a, 37b; and shutoff valves 38a to 38d. Each of these members is connected via the refrigerant flow path.

The compressor 35 has a function of compressing and discharging the refrigerant. The compressor 35 has a suction portion connected to the outdoor heat exchanger 36, and a discharge portion connected to the condenser 32 via the refrigerant flow path. The compressor 35 is driven by the control unit 40 and discharges the high-temperature, high-pressure refrigerant to the condenser 32 by compressing the refrigerant.

It should be noted that a known device such as a gas-liquid separator may be provided between the compressor 35 and the outdoor heat exchanger 36.

The outdoor heat exchanger 36 has a function of performing heat exchange between the heat of the refrigerant and the outside air. The outdoor heat exchanger 36 can absorb the heat from the outside air using a low-temperature, low-pressure refrigerant flowing therethrough, mainly when executing the heating operation mode, and can vaporize the refrigerant by absorbing the heat from the outside air. Moreover, the outdoor heat exchanger 36 can release the heat to the outside air by the high-temperature, high-pressure refrigerant flowing therethrough, and cools the refrigerant by releasing the heat to the outside air, mainly when executing the cooling operation mode.

The expansion valves 37a, 37b are throttle valves whose opening degrees can be adjusted by the control unit 40. In particular, when the heating operation mode is executed, the expansion valve 37a reduces the pressure of the refrigerant discharged from the condenser 32 to expand it, and then discharges the low-temperature, low-pressure refrigerant to the outdoor heat exchanger 36. Furthermore, when the cooling operation mode is executed, the expansion valve 37b reduces the pressure of the refrigerant from the outdoor heat exchanger 36 to expand it, and then discharge the low-temperature, low-pressure refrigerant to the evaporator 31.

The shutoff valves 38a to 38d are provided to control the flow path of the refrigerant. The opening and closing of the shutoff valves 38a to 38d are controlled by the control unit 40.

### (4. Control Unit 40)

The control unit 40 is electrically connected to the air conditioning device 20, and the HVAC unit 30 (if present). The control unit 40 controls the air conditioning device 20 and the HVAC unit 30 (including the heat pump cycle) depending on the operation mode. That is, the control unit 40 can control the humidity control device 20 to execute the adsorption (dehumidification) mode or the regeneration mode, and can control the HVAC unit 30 to execute the heating operation mode or the cooling operation (dehumidification) mode.

The control unit 40 is electrically connected to the shutoff valves 38a to 38d of the heat pump cycle, and can control the refrigerant flow path by opening and closing the shutoff valves 38a to 38d. Further, the control unit 40 is electrically connected to the expansion valves 37a, 37b of the heat pump cycle, and can control the degree of pressure reduction of the refrigerant by adjusting the opening degrees of the expansion valves 37a, 37b. Furthermore, the control unit 40 is also electrically connected to the air mix door 39, the ventilation fan 50, the first valve 60, the second valve 61, and the like, and can control these members.

The control unit 40 is generally an ECU (Engine (electronic) Control Unit), although not particularly limited thereto. The ECU is a CPU for executing various calculation processes, a ROM for storing programs and data required for its control, a RAM for temporarily storing results of calculations performed by the CPU, and input/output ports for inputting and outputting signals to and from the outside.

In the air conditioning system according to an embodiment of this invention, the control unit 40 can execute the adsorption mode and the regeneration mode as operation modes of the air conditioning device 20.

### <Adsorption Mode>

In the air conditioning system illustrated in FIGS. 2 and 4, the adsorption target substance is adsorbed by activating the ventilation fan 50 provided in the third flow path 11, controlling the first valve 60 so that the air flows into the first flow path 11, and allowing the air to flow through the air conditioning device 20.

In the air conditioning system illustrated in FIGS. 3 and 5, the adsorption target substance is adsorbed by activating the ventilation fan 50, controlling the second valve 61 so that the air flows into the third flow path 13, and controlling the first valve 60 so that the air flows into the first flow path 11, thereby allowing the air to flow through the air conditioning device 20.

Furthermore, in the air conditioning system illustrated in FIG. 6, the adsorption target substance is adsorbed by activating the ventilation fan 50 in the HVAC unit 30, controlling the first valve 60 so that the air flows into the first flow path 11, thereby allowing the air to flow through the air conditioning device 20. At this time, the ventilation fan 50 provided in the third flow path 13 may be activated. In the adsorption mode, the air conditioning device 20 is not heated.

### <Regeneration Mode>

In the air conditioning system illustrated in FIGS. 2, 4 and 6, the air is allowed to flow through the air conditioning device 20 by activating the ventilation fan 50 provided in the third flow path 13 to allow the air to flow into the third flow path 13, and controlling the first valve 60 so that the air flows into the second flow path 12. At this time, by heating the air conditioning device 20, the adsorption target substance adsorbed in the air conditioning device 20 is desorbed, so that the air conditioning device 20 can be regenerated.

In the air conditioning system illustrated in FIGS. 3 and 5, the air is allowed to flow through the air conditioning device 20 by activating the ventilation fan 50, controlling the second valve 61 so that the air flows into the third flow path 13, and controlling the first valve 60 so that the air flows into the second flow path 12. At this time, by heating the air conditioning device 20, the adsorption target substance adsorbed in the air conditioning device 20 is desorbed, so that the air conditioning device 20 can be regenerated.

In the air conditioning system according to Embodiment 1, the control unit 40 can execute the heating operation mode and the cooling operation mode as operation modes of the HVAC unit 30.

### <Heating Operation Mode>

The heating operation mode opens the shutoff valves 38a and 38b and closes the shutoff valves 38c and 38d, thereby forming a flow path such that the refrigerant sequentially flows through the compressor 35, the condenser 32, the expansion valve 37a, and the outdoor heat exchanger 36.

The refrigerant compressed by the compressor 35 enters the condenser 32 as a high-temperature, high-pressure refrigerant, exchanges heat with the air flowing through the flow path 10 in the HVAC unit 30, and releases the heat. The refrigerant that has left the condenser 32 is pressure-reduced and expanded by the expansion valve 37a to form a low-temperature, low-pressure refrigerant, and then exchanges the heat with the outside air in the outdoor heat exchanger 36 to absorb the heat, and returns to the compressor 35.

When this heating operation mode is executed, the air flowing through the flow path 10 in the HVAC unit 30 is heated by the condenser 32, and the heated air is allowed to flow into the vehicle interior. The temperature of the air flowing into the vehicle interior can be adjusted by controlling the opening degree of the air mix door 39.

### <First Cooling Operation Mode>

The cooling operation mode opens the shutoff valves 38c, 38d and closes the shutoff valves 38a and 38b, thereby forming a flow path such that the refrigerant sequentially flows through the compressor 35, the outdoor heat exchanger 36, the expansion valve 37b and the evaporator 31.

The refrigerant compressed by the compressor 35 to a high temperature and a high pressure is cooled by exchanging heat with the outside air and releasing the heat in the outdoor heat exchanger 36. The refrigerant that has left the outdoor heat exchanger 36 is pressure-reduced and expanded by the expansion valve 37b to form a low-temperature, low-pressure refrigerant, which enters the evaporator 31, and exchanges the heat with the air flowing through the flow path 10 in the HVAC unit 30 to absorb the heat. The refrigerant that has left the evaporator 31 returns to the compressor 35.

When the cooling operation mode is executed, the air flowing through the flow path 10 in the HVAC unit 30 is cooled by the evaporator 31, and the cooled air flows into the vehicle interior. The cooling operation mode is particularly useful when it is desired to rapidly cool the vehicle interior (strong cooling operation mode).

### <Second Cooling Operation Mode>

The second cooling operation mode opens the shutoff valves 38b, 38d and closes the shutoff valves 38a and 38c, thereby forming a flow path such that the refrigerant sequentially flows through the compressor 35, the condenser 32, the expansion valve 37a, the outdoor heat exchanger 36, the expansion valve 37b and the evaporator 31.

The condenser 32 and the expansion valve 37a are further provided on a downstream side of the compressor 35 in the refrigerant flow path in this cooling operation mode. In the cooling operation mode, the cooling of the air by the evaporator 31 and the heating of the air by the condenser 32 can be adjusted by controlling the opening degree of the air mix door 39, so that the temperature of the air can be controlled to the optimum temperature.

### Embodiment 2

The air conditioning system according to Embodiment 2 of this invention has the same components as those of the air conditioning system according to Embodiment 1 of this invention, and differs from the air conditioning system according to Embodiment 1 of this invention in that the flow rate of the air is controlled to satisfy predetermined conditions during the regeneration mode of the air conditioning device. Similarly, the method for controlling the air conditioning system according to Embodiment 2 of this invention differs from the method for controlling the air conditioning system according to Embodiment 1 of this invention in that the flow rate of the air is controlled to satisfy predetermined conditions during the regeneration mode of the air conditioning device. Therefore, only this difference will be described, and other descriptions will be omitted. It should be noted that components with the same numerical numbers as those appearing in the descriptions of the air conditioning system and the method for controlling the same according to Embodiment 1 of this invention are the same as the components of the air conditioning system and the method for controlling the same according to Embodiment 2 of this invention.

The air conditioning system and the method for controlling the same according to Embodiment 2 of this invention control the flow rate of the air so that the following conditions (1) to (5) are satisfied during the regeneration mode of the air conditioning device 20:
(1) when a temperature of the air is 120° C. or higher, a ratio of a maximum desorption amount [g/s] of the adsorption target substance in the air conditioning device 20 to the flow rate [m³/s] of the air is 1950 or less;
(2) when the temperature of the air is 90° C. or higher and lower than 120° C., the ratio of the maximum desorption amount [g/s] of the adsorption target substance in the air conditioning device 20 to the flow rate [m³/s] of the air is 600 or less;
(3) when the temperature of the air is 70° C. or higher and lower than 90° C., the ratio of the maximum desorption amount [g/s] of the adsorption target substance in the air conditioning device 20 to the flow rate [m³/s] of the air is 300 or less;
(4) when the temperature of the air is 50° C. or higher and lower than 70° C., the ratio of the maximum desorption amount [g/s] of the adsorption target substance in the air conditioning device 20 to the flow rate [m³/s] of the air is 130 or less; and
(5) when the temperature of the air is lower than 50° C., the ratio of the maximum desorption amount [g/s] of the adsorption target substance in the air conditioning device 20 to the flow rate [m³/s] of the air is 60 or less.

During the regeneration mode of the air conditioning device 20, when the desorption amount of the adsorption target substance is larger, a lower flow rate of the air results in accumulation of the adsorption target substance in the air conditioning device 20, leading to a decrease in the efficiency of the regeneration mode of the air conditioning device 20. Therefore, by controlling the ratio of the maximum desorption amount [g/s] of the adsorption target substance in the air conditioning device 20 to the flow rate of the air [m³/s] as described above, it is possible to suppress the adsorption target substance from being accumulated in the air conditioning device 20, thus enabling the regeneration mode of the air conditioning device 20 to be performed efficiently.

Here, the desorption amount of the adsorption target substance during the regeneration mode of the air conditioning device 20 varies depending on the flow rate of the temperature of the air. For this reason, the ratio of the maximum desorption amount [g/s] of the adsorption target substance in the air conditioning device 20 to the flow rate of the air [m³/s] is determined according to the temperature range of the air as in the conditions (1) to (5) described above.

The maximum desorption amount [g/s] of the adsorption target substance in the air conditioning device 20 can be determined by measuring the desorption amount of the adsorption target substance in the air conditioning device 20. Specifically, sensors for measuring the concentration of the adsorption target substance are provided at the inlet and outlet of the air conditioning device 20, the concentration of the adsorption target substance is measured at one-second intervals, and the desorption amount of the adsorption target substance is calculated using the following equation:

$$Desorption amount of adsorption target substance [ g / s ] = ( concentration of adsorption target substance at outlet of air conditioning device 20 [ g / kg ] - concentration of adsorption target substance at inlet of air conditioning device 20 [ g / kg ] ) \times flow rate of air [ kg / s ]$$

Then, among the desorption amounts of the adsorption target substance calculated above, the maximum desorption amount is determined to be the maximum desorption amount.

### EXAMPLES

Hereinafter, the present invention will be more specifically described with reference to Examples, but the present invention is not limited to these Examples.

### Experiment A

### <Production of Air Conditioning Device>

As ceramic raw materials were prepared BaCO₃ powder, TiO₂ powder, and La(NH₃)₃·6H₂O powder. These powders were weighed to have the required composition after firing, and dry-mixed to obtain a mixed powder. The dry mixing was performed for 30 minutes. To 100 parts by mass of the resulting mixed powder were then added water, a binder, a plasticizer, and a dispersant by an appropriate amount in the range of 3 to 30 parts by mass in total so as to obtain a ceramic formed body having a relative density of 64.8% after extrusion, and then kneaded to obtain a green body. Methylcellulose was used as the binder. Polyoxyalkylene alkyl ethers were used as the plasticizer and the dispersant.

The resulting green body was then fed into an extrusion molding machine and extruded using a predetermined die to form a honeycomb structure having the shape illustrated below after firing.

Shape of cross section and end face of honeycomb structure orthogonal to flow path direction: quadrangular;

Shape of cross section of cells orthogonal to flow path direction: quadrangular;

Thickness of partition walls: 0.100 mm;

Thickness of outer peripheral wall: 0.2 mm;

Cell density: 80 cells/cm²;

Cell pitch: 1.1 mm;

Cross-sectional area of honeycomb structure orthogonal to flow path direction: 6000 mm²;

Length of honeycomb structure in flow path direction: 10 mm;

Volume resistivity of materials comprised of outer peripheral wall and partition wall at 25° C.: 15 Ω·cm; and

Curie point of material making up outer peripheral wall and partition wall: 110° C.

Subsequently, the resulting honeycomb structure was subjected to dielectric drying and hot air drying, and then degreased (450° C. for 4 hours) in a sintering furnace in an air atmosphere, and then sintered in an air atmosphere. The firing was performed by maintaining the honeycomb structure at a temperature of 950° C. for 1 hour, then increasing the temperature to 1200° C. and maintaining it at 1200° C. for 1 hour, and then increasing the temperature to 1400° C. (maximum temperature) at a rate of 200° C./hour and maintaining it at a temperature of 1400° C. for 2 hours.

The pair of electrodes were formed on both end faces (first end face and second end face) of the resulting honeycomb structure. First, an electrode slurry containing aluminum (electrode material), ethyl cellulose and diethylene glycol monobutyl ether (organic binder) was prepared and applied to the first end face, and the electrode slurry was then dried to form an electrode on the first end face. Using the same electrode slurry, an electrode was formed on the second end face by applying the electrode slurry to the second end face and drying it.

The honeycomb structure with a pair of electrodes was then immersed in a slurry containing zeolite (adsorbent), an organic binder, and water, and the slurry adhering to excess positions (such as the periphery) was removed by blowing and wiping, and then dried at about 550° C. to form an absorbing layer having a thickness of 150 μm on surfaces of the partition walls and on a surface of the outer peripheral wall facing the cells.

The air conditioning device obtained as described above was placed in the air conditioning duct to construct the air conditioning system illustrated in FIG. 1. The adsorption target substance in the air conditioning system was moisture.

The air conditioning system was subjected to the adsorption mode, followed by the regeneration mode. In the adsorption mode, the air at a temperature of 25° C. and relative humidity of 40% was fed to the flow path at a flow rate of 380 L/min for 3 minutes. In the regeneration mode, while heating the air conditioning device by supplying power from a power source connected to the control unit, the air at a temperature of 25° C. and relative humidity of 40% was allowed to flow through the flow path for 1 minute. The average power supplied to the air conditioning device and the flow rate of the air during the regeneration mode are shown in Table 1. The average power and the flow rate of the air were controlled by adjusting the output of the power source and the rotation speed of the ventilation fan, respectively.

In the regeneration mode, the absolute humidity [g/m³] at the inlet and outlet of the air conditioning device was measured, and an amount of moisture released [g] was calculated by the following equation:

Amount of moisture released [g]=(absolute humidity at outlet of air conditioning device [g/m³]−absolute humidity at inlet of air conditioning device [g/m³])×flow rate [m³/min]×duration time for regeneration mode [min]

In this evaluation, if the amount of moisture released is 1.0 g or more, the moisture release performance can be good, and in particular, if the amount of moisture released is 1.4 g or more, the moisture release performance can be excellent.

The above results are shown in Table 1.

TABLE 1

| | Flow Rate | Average | Ratio | Amount of |
|---|---|---|---|---|
| | of Air | Power | (Flow Rate of Air/ | Moisture |
| | [L/min] | [W] | Average Output) | Released [g] |
| Ex. 1 | 45 | 450 | 0.10 | 1.32 |
| Ex. 2 | 100 | 500 | 0.20 | 1.89 |
| Ex. 3 | 255 | 150 | 1.70 | 1.72 |
| Ex. 4 | 380 | 200 | 1.90 | 1.20 |
| Comp. 1 | 25 | 600 | 0.04 | 0.58 |
| Comp. 2 | 25 | 300 | 0.08 | 0.67 |
| Comp. 3 | 400 | 200 | 2.00 | 0.63 |
| Comp. 4 | 700 | 200 | 3.50 | 0.53 |

As shown in Table 1, Examples 1 to 4 in which the ratio of the flow rate of the air [L/min] to the average power [W] supplied to the air conditioning device was controlled to 0.10 to 1.90 during the regeneration mode of the air conditioning device had a higher amount of moisture released and superior moisture release performance as compared to Comparative Examples 1 to 4 in which the ratio was controlled outside the predetermined range.

### Experiment B

An air conditioning device was produced in the same manner as in Experiment A. In the formation of the adsorbing layer, the amount of zeolite (adsorbent) was adjusted to control the amount of adsorbent contained in the adsorbing layer formed on each of the surfaces of the partition walls and the outer peripheral wall facing the cells to the values shown in Table 2.

The air conditioning device obtained as described above was then placed in the air conditioning duct to construct the air conditioning system as illustrated in FIG. 1. The adsorption target substance in the air conditioning system was moisture.

The air conditioning system was then subjected to the adsorption mode, followed by the regeneration mode. In the adsorption mode, the air at a temperature of 20° C. and relative humidity of 30% was fed to the flow path at a flow rate of 0.0117 m³/s for 3 minutes. In the regeneration mode, while heating the air conditioning device by supplying power from a power source connected to the control unit, the air shown in Table 2 and relative humidity of 30% was allowed to flow through the flow path for 3 minutes. At this time, the ratio of the maximum desorption amount [g/s] of the adsorption target substance in the air conditioning device to the flow rate [m³/s] of the air was controlled to be the values shown in Table 2. The maximum desorption amount of the adsorption target substance was calculated by the method described above, and the flow rate of the air was controlled by adjusting the rotation speed of the ventilation fan.

In the regeneration mode, the absolute humidity [g/m³] at the inlet and outlet of the air conditioning device was measured, and the amount of moisture released [g] was calculated in the same manner as in Experiment A. The results are summarized in Table 2.

TABLE 2

| | | Tem- | | | |
|---|---|---|---|---|---|
| | Amount of | perature | Ratio (Maximum | Amount of | |
| | Adsorbent | of Air | Desorption Amount/ | Moisture | Classi- |
| Nos. | [g] | [° C.] | Flow Rate of Air | Released [g] | fication |
| A-1 | 60 | 140 | 1950 | 15.0 | Ex. |
| A-2 | | | 2400 | 13.6 | Comp. |
| B-1 | 40 | 100 | 600 | 6.7 | Ex. |
| B-2 | | | 1000 | 4.5 | Comp. |
| C-1 | 35 | 80 | 300 | 5.8 | Ex. |
| C-2 | | | 520 | 3.6 | Comp. |
| D-1 | 30 | 60 | 130 | 5.8 | Ex. |
| D-2 | | | 250 | 3.5 | Comp. |
| E-1 | 20 | 40 | 60 | 3.3 | Ex. |
| E-2 | | | 100 | 1.8 | Comp. |

As shown in Table 2, during the regeneration mode of the air conditioning device at a temperature of air of 140° C., No. A-1 (Example) in which the ratio of the maximum desorption amount (amount of moisture released) [g/s] of the adsorption target substance (moisture) in the air conditioning device to the flow rate [m³/s] of the air was controlled to 1950 had a higher amount of moisture released and superior moisture release performance as compared to No. A-2 (Comparative Example) in which the ratio was controlled to 2400. In the comparisons between No. B-1 (Example) and No. B-2 (Comparative Example), No. C-1 (Example) and No. C-2 (Comparative Example), No. D-1 (Example) and No. D-2 (Comparative Example), and No. E-1 (Example) and No. E-2 (Comparative Example), Examples had a higher amount of moisture released and superior moisture release performance than those of Comparative Examples.

As can be seen from the above results, according to this invention, it is possible to provide an air conditioning system and a method for controlling the same, which can efficiently perform the regeneration mode of the air conditioning device.

### DESCRIPTION OF REFERENCE NUMERALS

10 flow path
11 first flow path
12 second flow path
13 third flow path
14 fourth flow path
15 duct
20 air conditioning device
21 honeycomb structure
22 outer peripheral wall
23a first end face
23b second end face
24 cell
25 partition wall
26 adsorbing layer
27a, 27b pair of electrodes
28 terminal
30 HVAC unit
31 evaporator
32 condenser
33a defroster opening
33b foot opening
33c face opening
34a defroster door
34b foot door
34c face door
35 compressor
36 outdoor heat exchanger
37a, 37b expansion valve
38a-38d shutoff valve
39 air mix door
40 control unit
50 ventilation fan
51a inside air feed port
51b outside air feed port
52 damper
60 first valve
61 second valve

1. An air conditioning system, comprising:
a flow path through which air can flow;
at least one air conditioning device provided in the flow path and configured to execute an adsorption mode in which at least one adsorption target substance is adsorbed and a regeneration mode in which the adsorption target substance is desorbed, the air conditioning device comprising a substrate portion heatable by application of voltage, and an adsorption portion comprising an adsorbent configured to adsorb and desorb the adsorption target substance; and
a control unit configured to control a flow rate of the air flowing through the flow path and the air conditioning device,
wherein the control unit controls a ratio of a flow rate [L/min] of the air to an average power [W] supplied to the air conditioning device to 0.10 to 1.90 during the regeneration mode of the air conditioning device.

2. The air conditioning system according to claim 1, wherein the control unit controls the ratio of the flow rate [L/min] of the air to the average power [W] supplied to the air conditioning device to 0.20 to 1.70 during the regeneration mode of the air conditioning device.

3. The air conditioning system according to claim 1, wherein the control unit changes at least one of the power supplied to the air conditioning device and the flow rate of the air during the regeneration mode of the air conditioning device.

4. An air conditioning system, comprising:
a flow path through which air can flow;
at least one air conditioning device provided in the flow path and configured to execute an adsorption mode in which at least one adsorption target substance is adsorbed and a regeneration mode in which the adsorption target substance is desorbed, the air conditioning device comprising a substrate portion heatable by application of voltage, and an adsorption portion comprising an adsorbent configured to adsorb and desorb the adsorption target substance; and
a control unit configured to control a flow rate of the air flowing through the flow path and the air conditioning device,
wherein the control unit controls the flow rate of the air during the regeneration mode of the air conditioning device to satisfy the following conditions:
(1) when a temperature of the air is 120° C. or higher, a ratio of a maximum desorption amount [g/s] of the adsorption target substance in the air conditioning device to the flow rate [m³/s] of the air is 1950 or less;
(2) when the temperature of the air is 90° C. or higher and lower than 120° C., the ratio of the maximum desorption amount [g/s] of the adsorption target substance in the air conditioning device to the flow rate [m³/s] of the air is 600 or less;
(3) when the temperature of the air is 70° C. or higher and lower than 90° C., the ratio of the maximum desorption amount [g/s] of the adsorption target substance in the air conditioning device to the flow rate [m³/s] of the air is 300 or less;
(4) when the temperature of the air is 50° C. or higher and lower than 70° C., the ratio of the maximum desorption amount [g/s] of the adsorption target substance in the air conditioning device to the flow rate [m³/s] of the air is 130 or less; and
(5) when the temperature of the air is lower than 50° C., the ratio of the maximum desorption amount [g/s] of the adsorption target substance in the air conditioning device to the flow rate [m³/s] of the air is 60 or less.

5. The air conditioning system according to claim 1, wherein the air conditioning device comprises:
a honeycomb structure having an outer peripheral wall and partition walls provided on an inner side of the outer peripheral wall, the partition walls defining a plurality of cells, each of the cells extending from a first end face to a second end face of the honeycomb structure to form a flow path for the air;
an adsorbing layer containing the adsorbent, the adsorbing layer being provided on a surface of each of the partition walls; and
a pair of electrodes provided on the first end face and the second end face of the honeycomb structure, or on the outer peripheral wall parallel to an extending direction of the cells of the honeycomb structure.

6. The air conditioning system according to claim 5, wherein at least the partition walls of the honeycomb structure are made of a material having a positive temperature coefficient (PTC) property.

7. The air conditioning system according to claim 1, wherein the flow path branches into a first flow path for allowing the air to flow into a room interior and a second flow path for discharging the air to a room exterior on a downstream side, and further comprises a first valve configured to switch the flow of the air between the first flow path and the second flow path.

8. The air conditioning system according to claim 7, wherein the control unit is configured to control the first valve, and
wherein the control unit switches the first valve so that the air flows into the first flow path during the adsorption mode, switches the first valve so that the air flows into the second flow path during the regeneration mode, and heats the substrate portion.

9. The air conditioning system according to claim 1, further comprising a ventilation fan for adjusting the flow rate of the air within the flow path,
wherein the control unit controls the flow rate of the air by adjusting a rotation speed of the ventilation fan.

10. The air conditioning system according to claim 1, wherein the adsorption target substance may be moisture.

11. A method for controlling an air conditioning system, the air conditioning system comprising:
a flow path through which air can flow;
at least one air conditioning device provided in the flow path and configured to execute an adsorption mode in which at least one adsorption target substance is adsorbed and a regeneration mode in which the adsorption target substance is desorbed, the air conditioning device comprising a substrate portion heatable by application of voltage, and an adsorption portion comprising an adsorbent configured to adsorb and desorb the adsorption target substance; and
a control unit configured to control a flow rate of the air flowing through the flow path and the air conditioning device,
wherein the control unit controls a ratio of a flow rate [L/min] of the air to an average power [W] supplied to the air conditioning device to 0.10 to 1.90 during the regeneration mode of the air conditioning device.

12. The method for controlling an air conditioning system according to claim 11, wherein the control unit controls the ratio of the flow rate [L/min] of the air to the average power [W] supplied to the air conditioning device to 0.20 to 1.70 during the regeneration mode of the air conditioning device.

13. The method for controlling an air conditioning system according to claim 11, wherein the control unit changes at least one of the power supplied to the air conditioning device and the flow rate of the air during the regeneration mode of the air conditioning device.

14. A method for controlling an air conditioning system, the air conditioning system comprising:
a flow path through which air can flow;
at least one air conditioning device provided in the flow path and configured to execute an adsorption mode in which at least one adsorption target substance is adsorbed and a regeneration mode in which the adsorption target substance is desorbed, the air conditioning device comprising a substrate portion heatable by application of voltage, and an adsorption portion comprising an adsorbent configured to adsorb and desorb the adsorption target substance; and
a control unit configured to control a flow rate of the air flowing through the flow path and the air conditioning device,
wherein the control unit controls the flow rate of the air during the regeneration mode of the air conditioning device to satisfy the following conditions:
(1) when a temperature of the air is 120° C. or higher, a ratio of a maximum desorption amount [g/s] of the adsorption target substance in the air conditioning device to the flow rate [m³/s] of the air is 1950 or less;
(2) when the temperature of the air is 90° C. or higher and lower than 120° C., the ratio of the maximum desorption amount [g/s] of the adsorption target substance in the air conditioning device to the flow rate [m³/s] of the air is 600 or less;
(3) when the temperature of the air is 70° C. or higher and lower than 90° C., the ratio of the maximum desorption amount [g/s] of the adsorption target substance in the air conditioning device to the flow rate [m³/s] of the air is 300 or less;
(4) when the temperature of the air is 50° C. or higher and lower than 70° C., the ratio of the maximum desorption amount [g/s] of the adsorption target substance in the air conditioning device to the flow rate [m³/s] of the air is 130 or less; and
(5) when the temperature of the air is lower than 50° C., the ratio of the maximum desorption amount [g/s] of the adsorption target substance in the air conditioning device to the flow rate [m³/s] of the air is 60 or less.
